(19) United States
(12) Patent Application Publication
(10) Pub. No.: US 2005/0207367 A1
(43) Pub. Date: Sep. 22, 2005

(54) Method for channel quality indicator computation and feedback in a multi-carrier communications system

(76) Inventors: Eko N. Onggosanusi, Allen, TX (US); Anand G. Dabak, Plano, TX (US); Timothy M. Schmidl, Dallas, TX (US); Aris Papasakellariou, Dallas, TX (US); Yan Hui, San Diego, CA (US)

Correspondence Address: TEXAS INSTRUMENTS INCORPORATED, P O BOX 655474, M/S 3999, DALLAS, TX, 75265, US

(21) Appl. No.: 11/085,590

(22) Filed: Mar. 21, 2005

Related U.S. Application Data
(60) Provisional application No. 60/555,728, filed on Mar. 22, 2004.

(51) Int. Cl. H04J 1/16; H04J 3/14

(52) U.S. Cl. 370/315

(57) ABSTRACT

Method for computing and transmitting channel quality information in a multi-carrier communications system. A preferred embodiment comprises receiving a transmission from a transmitter, wherein the transmission occurs over a plurality of carriers, measuring a channel condition for each carrier in a plurality of carriers, computing a channel quality indicator based upon the measured channel condition, and providing the channel quality indicator to the transmitter. The channel quality indicator can be used at the transmitter to schedule transmissions to various users in the multi-carrier communications system to maximize utilization of the carriers as well as overall network performance.

This application claims the benefit of U.S. Provisional Application No. 60/555,728, filed Mar. 22, 2004, entitled “Methods of Channel Quality Indicator (CQI) Computation and Feedback for 3xEV-DV” which application is hereby incorporated by reference.

### TECHNICAL FIELD

The present invention relates generally to a method for digital communications, and more particularly to a method for computing and transmitting channel quality information in a multi-carrier communications system.

### BACKGROUND

Communications channel (or simply, channel) quality can have a significant impact on the performance of a wireless communications system (communications system). A communications system with channels with high channel quality can transfer data at a higher rate and with a lower latency than a communications system with channels with low channel quality. Given a pair of communications channels in a communications system, a communications channel with high channel quality will more likely support a higher maximum bandwidth as well as have a lower error rate than a communications channel with low channel quality. Channel quality should therefore be a factor that needs to be considered when scheduling message transmissions in a communications system.

A channel quality indicator (CQI) can be a value (or values) representing a measure of channel quality for a given channel. Typically, a high value CQI is indicative of a channel with high quality and vice versa. A CQI for a channel can be computed by making use of performance metric, such as a signal-to-noise ratio (SNR), signal-to-interference plus noise ratio (SINR), signal-to-noise plus distortion ratio (SNDR), and so forth of the channel. These values and others can be measured for a given channel and then used to compute a CQI for the channel. The CQI for a given channel can be dependent upon the transmission (modulation) scheme used by the communications system. For example, a communications system using code-division multiple access (CDMA) can make use of a different CQI than a communications system that makes use of orthogonal frequency division multiplexing (OFDM). In more complex communications systems, such as those making use of multiple-input multiple output (MIMO) and space-time coded systems, the CQI used can also be dependent on receiver type. Other factors that may be taken into account in CQI are performance impairments, such as Doppler shift, channel estimation error, interference, and so forth.

One commonly used technique to compute CQI is to determine a value of a metric for a channel and then use the value to compute the CQI. The CQI for the channel can then be used in a variety of operations involving the channel, such as scheduling transmissions on the channel. In a communications system that has a plurality of channels, a single CQI can be used for multiple channels as long as they are sufficiently close in frequency to each other. By using a single CQI, it is not necessary to compute a CQI for each channel and hence computation and processing time can be saved.

One disadvantage of the prior art is that if the channels are not sufficiently close to one another in frequency, then a CQI computed for one channel may not be applicable to other channels. This is because channels centered at different frequencies can behave differently from one another and a channel may have an interferer while another does not. This is often the case in a multi-carrier communications system, wherein the carriers have relatively large bandwidths and may be separated from one another by large frequency ranges.

Another disadvantage of the prior art is that even if the channels are sufficiently close to one another in frequency, the use of a CQI that was computed for a single channel by other channels only provides an approximation and not an accurate estimate. For example, a first channel that may be very close (in frequency) to a second channel, that is used to compute the CQI, may have an interferer present in its transmission band. The interferer may be sufficiently large to negatively impact the transmissions carried in the first channel. Therefore, a CQI computed for the second channel does not accurately approximate the channel quality of the first channel.

### SUMMARY OF THE INVENTION

These and other problems are generally solved or circumvented, and technical advantages are generally achieved, by preferred embodiments of the present invention which provides a method for exploiting diversity in a multi-carrier communications system to improve retransmission performance.

In accordance with a preferred embodiment of the present invention, a method for providing channel quality indicators to a transmitter of a multi-carrier communications system is provided. The method comprises receiving a transmission from the transmitter, wherein the transmission occurs over a plurality of carriers, measuring a channel condition for each carrier in the plurality of carriers, computing a channel quality indicator based upon the measured channel condition, and providing the channel quality indicator to the transmitter.

In accordance with another preferred embodiment of the present invention, a method for generating channel quality indicators in a multi-carrier communications system is provided. The method comprises transmitting a message to each electronic device in the multi-carrier communications system, wherein a transmission to an electronic device occurs over every carrier assigned to the electronic device, and receiving a channel quality indicator from each electronic device.

An advantage of a preferred embodiment of the present invention is that multiple channels of a multi-carrier communications system are used in the computation of a channel quality indicator, therefore the computation is a more accurate estimation of the quality of the individual carriers.

A further advantage of a preferred embodiment of the present invention is that computation time can be saved by computing a joint channel quality indicator for multiple carriers. Since the carriers in the joint channel quality indicator were all used in the computation of the joint channel quality indicator, an accurate estimation of the quality of the carriers is achieved.

Yet another advantage of a preferred embodiment of the present invention is that actual transmissions on the carriers can be used to compute the channel quality indicator. Therefore, the need to use special transmissions whose purpose is solely for measuring channel quality is not needed. This can improve the overall performance of the communications system by reducing overhead.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a frequency band diagram of a frequency allocation of carriers in a multi-carrier communications system;

FIG. 2 is a diagram of a pair of electronic devices communicating over a plurality of carriers;

FIG. 3 is a diagram of actions performed by a base station and user equipment in the computation of a CQI and the use of the CQI to schedule transmissions, according to a preferred embodiment of the present invention;

FIG. 4 is a diagram of events in the computation of a CQI and its use in a multi-carrier communications system with a BS and a plurality of UEs, wherein each carrier has its own CQI, according to a preferred embodiment of the present invention;

FIG. 5 is a diagram of events in the computation of a CQI and its use in a multi-carrier communications system with a BS and a plurality of UEs, wherein a single CQI represents a plurality of carriers, according to a preferred embodiment of the present invention; and

FIG. 6 is a diagram of a portion of a BS of a multi-carrier communications system, wherein the BS makes use of CQI to schedule and determine modulation-coding schemes for transmissions from the BS, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a three-carrier multi-carrier communications system, such as 3xEV-DV, which is an extension to a single carrier communications system 1xEV-DV. 1xEV-DV is an evolution of CDMA2000 and supports voice and high-speed data using code-division multiple access (CDMA). The invention may also be applied, however, to multi-carrier communications systems in general, with no limit on the number of carriers, such as NxEV-DV (an N-carrier EV-DV system) and an extension to 1xEV-DO, which is yet another evolution of CDMA2000, which can be termed NxEV-DO system. Furthermore, each carrier in the multi-carrier communications system may use different modulation techniques or they may all use a single modulation technique. For example, an exemplary multi-carrier communications system may have a single carrier using CDMA modulation and remaining carriers using any combination of CDMA and orthogonal frequency division multiplexing (OFDM). In addition to using different modulations, the carriers in an exemplary multi-carrier communications system may make use of different modulation parameters, such as different spreading codes, numbers of tones, and so forth, as well as different modulations.

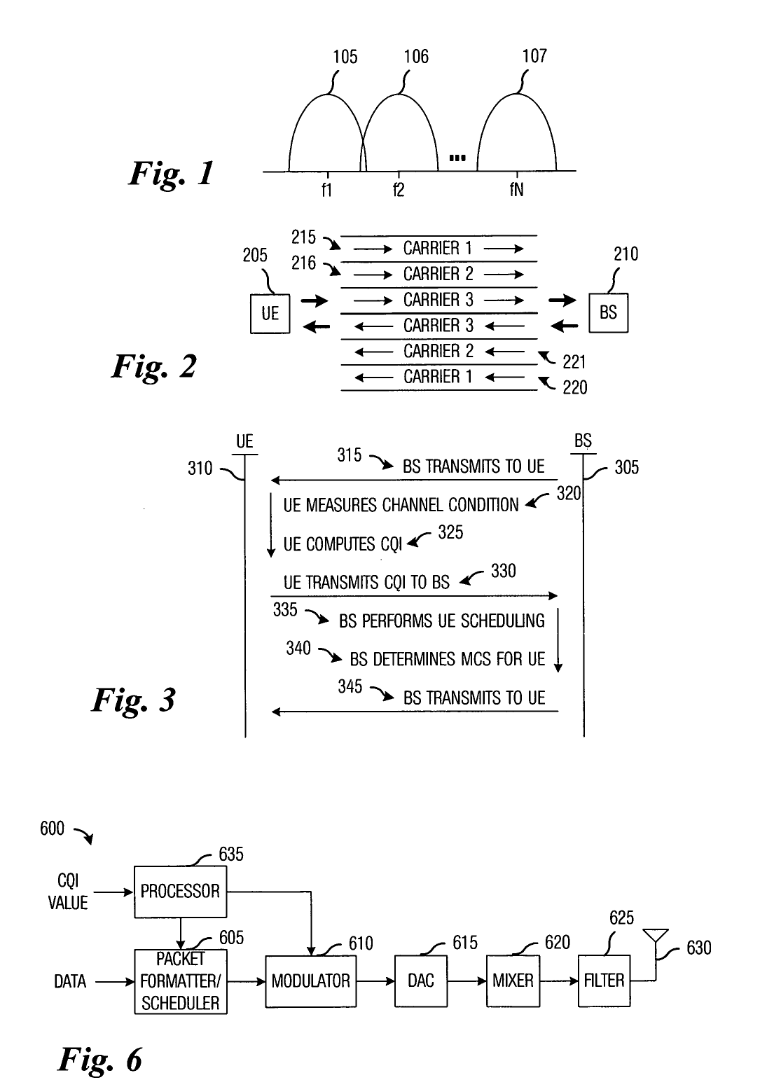

With reference now to FIG. 1, there is shown a frequency band diagram illustrating a frequency allocation of carriers in an exemplary multi-carrier communications system. The exemplary multi-carrier communications system, as shown in FIG. 1, has N carriers, wherein N is an integer number. Each carrier in the exemplary multi-carrier communications system, such as carrier #1 105, carrier #2 106, and carrier #N 107, can span a particular frequency range. Each frequency band can have a center frequency, frequency f1 for carrier #1 105, for example, as well as a certain bandwidth. Each band can have a different bandwidth, the same bandwidth, or combinations thereof. Advantages arising from using multiple carriers rather than a single carrier can include compatibility with legacy systems, the use of different data transmission schemes and modulation schemes in different carriers, the ability to skip certain portions of the spectrum that may already be in use, and so forth. Note that the term carrier can be used interchangeably with the term channel.

With reference now to FIG. 2, there is shown a diagram illustrating a pair of electronic devices communicating over a plurality of carriers. As shown in FIG. 2, the pair of electronic devices comprises user equipment (UE) 205 and a base station (BS) 210. However, it can be possible for UE 205 to communicate directly with other UE 205 or for one BS 210 to communicate with another BS 210. When the UE 205 is transmitting to the BS 210, it has several carriers at its disposal, including carrier #1 215 and carrier #2 216. Note that within a single carrier, such as carrier #1 215, there may exist multiple channels. When the BS 210 is transmitting to the UE 205, it can also transmit over a plurality of carriers, such as carrier #1 220 and carrier #2 221.

When an electronic device, such as the UE 205, has data to transmit, the selection of which carrier(s) to use can be dependent upon factors such as carrier and channel quality indicators, current communications network load, data priority, quality of service requirements, and so forth. The carrier selection, transmission prioritization, scheduling, and so on can be made at a transmitter of the electronic device.

The quality of a channel is very important to the performance of the channel. As discussed previously, with two similar channels in a communications system, if a first channel is of better quality than a second channel, then the first channel can likely transmit more data at a higher transfer rate with a lower latency than the second channel. Therefore, it is important to have a measure of channel quality that can be used to perform tasks such as transmission scheduling, channel usage scheduling, channel data transmission scheme, channel modulation scheme selection, and so forth.

With reference now to FIG. 3, there is shown a diagram illustrating actions performed by a BS and a UE in the computation of a CQI and the use of the CQI to schedule transmissions, according to a preferred embodiment of the present invention. The diagram shown in FIG. 3 illustrates actions taken by the BS and the UE in the computation of a CQI and its subsequent use by the BS in the scheduling of transmissions. The actions taken by the BS and the UE are displayed in chronological fashion with increasing time in a downward direction. Actions taken by the BS are displayed along a first vertical line 305 on the right side of the diagram, while actions taken by the UE are displayed along a second vertical line 310 on the left side of the diagram. Exchanges between the BS and the UE are shown as horizontal lines pointed in the direction of the exchange.

The computation of a CQI for a channel (or channels) can begin with a transmission from the BS to the UE (highlight 315). The transmission may be a normal transmission of data from the BS to the UE, a transmission of control information, a special transmission intended solely to measure the quality of the channel(s), or so forth. With the reception of the transmission at the UE, the UE can obtain a measure of the channel quality (highlight 320). As an alternative to actually having the BS transmit to the UE, especially when the BS may not have anything to transmit to the UE, the UE may obtain a measure of the channel quality by measuring a designated channel, such as a pilot channel. The pilot channel is normally used by a UE to become synchronized with the multi-carrier communications system as well as obtain control information from the BS.

According to a preferred embodiment of the present invention, the UE can obtain a measure of the channel quality by examining a metric such as a signal-to-noise ratio (SNR), signal-to-interference plus noise ratio (SINR), signal-to-noise plus distortion ratio (SNDR), and so forth of the channel(s). From one or more of these metrics, the UE can compute a CQI for the channel(s) (highlight 325). When multiple channels are involved, the UE can compute a joint CQI for all of the channels or a separate CQI for each one of the channels.

After computing the CQI for the channel(s), the UE can then transmit the CQI back to the BS (highlight 330). According to a preferred embodiment of the present invention, the UE can quantize and/or label the CQI prior to transmitting the CQI back to the BS. Quantization may involve categorization the CQI into one of a fixed number of possible values while labeling can involve the assignment of an entry representing a certain range of metric values in a table or index like manner. For example, the transmitted CQI may correspond to a largest frame size and modulation scheme that can be properly received by the UE within a given transmission time. Alternatively, the transmitted CQI may provide a maximum data rate that can be supported. Additionally, the CQI can be error protected by the application of an error detecting/correcting code. Note that the error detecting/correcting code used to protect the transmitted CQI should have a low latency so that fast decoding at the BS is permitted.

Upon receipt of the CQI and any needed decoding and error correcting, the BS can use the CQI to schedule transmissions from the UE (and other UEs) (highlight 335). The scheduling can involve the assignment of transmissions to certain channels as well as transmission order and time. In addition to scheduling transmissions based on the CQI, the BS can also make modulation-coding scheme (MCS) assignments for the channels (highlight 340). The assignment of MCS can help to increase frequency diversity, which can improve overall performance, when an adaptive modulation-coding scheme (AMCS) is used on channels with adequate quality. After scheduling and MCS determination based upon the CQI, the BS can permit transmissions to the UE (highlight 345). For a detailed discussion of packet scheduling, AMCS, and MCS, refer to co-assigned, co-pending patent application entitled “Packet Transmission Scheduling in a Multi-Carrier Communications System,” attorney docket number TI-38144, which application is hereby incorporated by reference.

The computation and feedback of the CQI should be performed with a degree of regularity to help ensure that the CQI for the channel(s) remain up-to-date. If a large period of time is allowed to elapse between successive CQI computations, then it can be possible for the channel(s) to change and the CQI become out-of-date. However, continuous CQI computation and feedback can consume significant amounts of processing power (to compute, quantize, and encode the CQI) as well as communications system bandwidth (to transmit transmissions for CQI computation as well as feeding back the CQI).

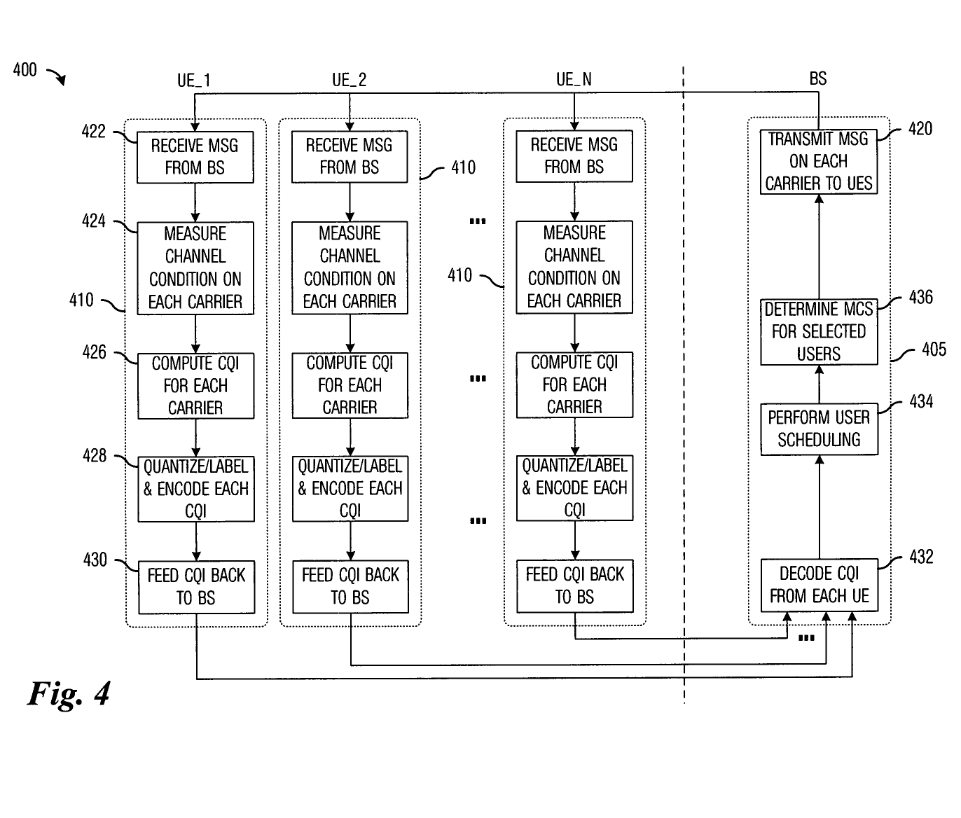

With reference now to FIG. 4, there is shown a diagram illustrating a sequence of events in the computation of a channel quality indicator and its use in a multi-carrier communications system with a BS and a plurality of UEs, wherein each channel has its own channel quality indicator, according to a preferred embodiment of the present invention. The diagram shown in FIG. 4 illustrates a sequence of events 400 for CQI computation and feedback in a multi-carrier communications system. The diagram illustrates the sequence of events 400 for the multi-carrier communications system with one base station 405 (labeled BS) and a plurality of UEs 410 (labeled UE_1, UE_2, and UE_N) and displays events and actions performed by the BS and UEs.

The sequence of events 400 can begin in the BS 405 with the BS 405 transmitting a message to each of the UEs 410 on a plurality of carriers (block 420). Note that the plurality of carriers can be two carriers, three carriers, or any integer number of carriers. The message transmitted may be one of a variety of messages, such as a normal data message, the message may also contain a specially designed payload to simplify the determination of channel quality, the message may be a normal control message of the multi-carrier communications system, or so forth. Preferably, BS 405 will transmit the message on every carrier in the multi-carrier communications system. However, if the multi-carrier communications system has a large number of carriers, then the BS 405 may transmit on a subset of carriers. Alternatively, the BS 405 may allocate certain subsets of carriers to different UEs 410. For example, a first set of carriers may be allocated to UEs 1 through 5 and a second set of carriers may be allocated to UEs 6 through 10. In such a situation, the BS 405 would transmit messages to UEs 410 only on carriers allocated to the UEs 410.

After the BS 405 transmits the message(s) to the UEs 410 (for example UE_1, UE_2, UE_N), the UEs 410 receive the message from the BS 405 on the carriers used by the BS 405 (block 422). The UEs 410 can then measure channel condition of each carrier that carried the message (block 424). Alternatively, rather than transmitting to the UEs 410 and having the UEs 410 measure the channel condition of each carrier carrying the transmission, the UEs 410 can monitor a designated channel associated with a carrier and make channel condition measurements based on the designated channels. For example, the UE 410 may make a channel condition measurement based on a pilot channel. As discussed previously, the UE 410 may use one of a plurality of performance metrics, such as a signal-to-noise ratio (SNR), signal-to-interference plus noise ratio (SINR), signal-to-noise plus distortion ratio (SNDR), and so forth to measure the channel condition. From the measured channel condition, the UE 410 can compute a CQI for each carrier (block 426). The CQI may be a simple numerical value that is dependent upon the measured channel condition and can be representative of the quality of the channel. The UE 410 can compute the CQI for each carrier used to carry the message. Since the UE 410 needs to compute a CQI for each carrier, the UE 410 may continually monitor each of the carriers, periodically monitor each carrier, or occasionally monitor each carrier. The decision may be based upon computational capabilities of the UE 410 as well as factors such as current transmission loads on the UE 410, current overall network performance, and so forth.

The UE 410 can then quantize and label the computed CQI for each carrier and then encode the CQI for transmission (block 428). The quantization of the CQI may involve the assignment of a discrete value that is closest to the computed CQI value, while the labeling of the CQI can involve the assignment of an entry representing a certain range of metric values in a table or index like manner. The encoding of the quantized and labeled CQI value can involve the application of an error detecting and correcting code to help protect the CQI value from damage during transmission. Finally, the encoded, quantized and labeled CQI value can be fedback to the BS 405 via a feedback control channel (block 430). Note that if there is a large number of UEs 410, it may not be possible to transmit the CQI values from each UE 410 to the BS 405 in a single transmit time interval. In such a situation, a single UE 410 (or a small number of UE 410) may transmit its CQI value in a single transmit time interval. The number of UEs 410 that can transmit in a single transmit time interval may be specified during a configuration stage of the multi-carrier communications system.

Back at the BS 405, the BS 405 after having received the CQI values from each of the UEs 410 can decode the CQI values (block 432). Note that part of the decoding process may involve error checking and correcting. Since each UE 410 computed a CQI value for each carrier, then the BS 405 will receive a number of CQIs that is equal to the number of UEs 410 in the multi-carrier communications system multiplied by the number of carriers for each UE 410. The BS 405 can then make use of the CQI values from the various UEs 410 to schedule transmissions to the UEs 410 (block 434). For example, the BS 405 may elect to place more transmissions on a carrier that has a high CQI value and fewer transmissions on a carrier that has a low CQI value. In addition to scheduling transmissions to the UEs 410, the BS 405 can make MCS determinations (block 436) for each of the carriers, using the CQI values. For example, in a carrier with a low CQI value, the BS 405 may elect to use a modulation-coding scheme that will provide high degree of tolerance to errors at the expense of data throughput to help ensure that transmissions will be successfully received. While in a carrier with a high CQI, the BS 405 may elect to use a modulation-coding scheme that will minimize overhead to maximize data throughput. After the BS 405 has performed scheduling (block 434) and MCS determinations (block 436), the BS 405 can commence transmissions to the UEs 410 (block 420).

The computation and feedback of CQI values for each carrier by each UE 410 can be well suited for situations when transmissions to each UE 410 at any given time, such as for a given transmit time interval, occurs over a single carrier and that carrier is to be selected based upon a short-term channel condition (as reflected by the CQI values). In a situation such as this, the channel quality for one carrier is of interest. Therefore, separate CQI values should be assigned to each carrier. With each carrier described by its unique CQI value, the BS 405 can readily select the carrier to transmit the transmission to the UE 410.

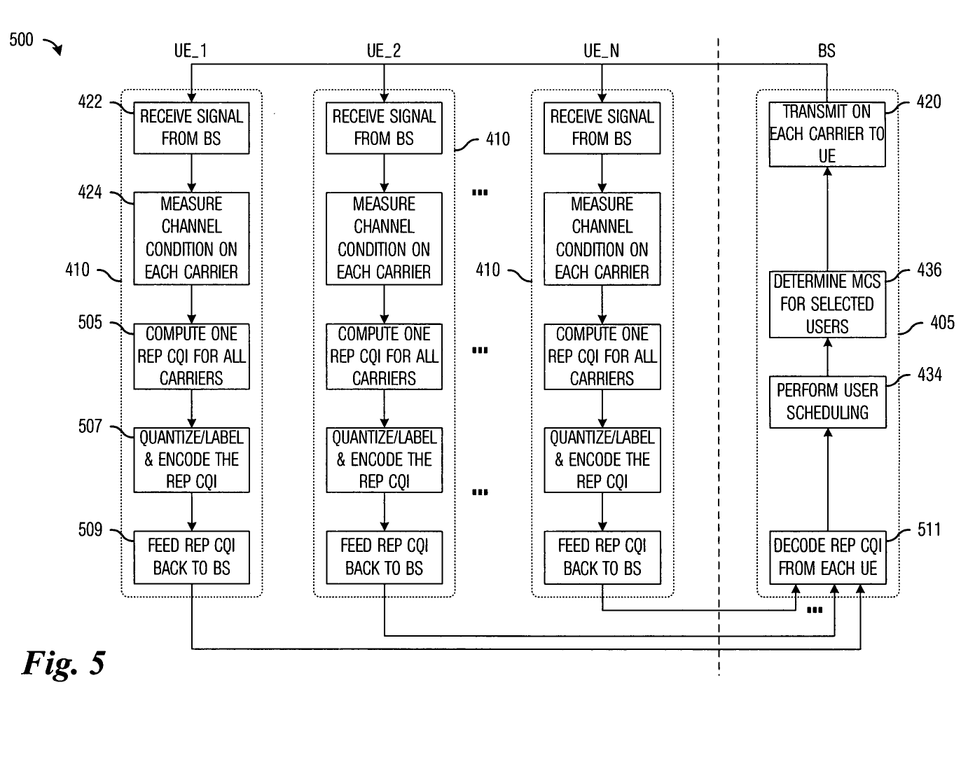

With reference now to FIG. 5, there is shown a diagram illustrating a sequence of events in the computation of a channel quality indicator and its use in a multi-carrier communications system with a BS and a plurality of UEs, wherein a joint channel quality indicator is computed, according to a preferred embodiment of the present invention. The diagram shown in FIG. 5 illustrates a sequence of events 500 for CQI computation and feedback in a multi-carrier communications. The diagram illustrates the sequence of events 500 for the multi-carrier communications system with one base station 405 (labeled BS) and a plurality of UEs 410 (labeled UE_1, UE_2, and UE_N) and displays events and actions performed by the BS and UEs and is substantially similar to the sequence of events 400 (FIG. 4) with exception in the CQI computation by the UEs 410 and the CQI decoding by the BS 405.

As with the sequence of events 400, the sequence of events 500 can begin with the BS 405 transmitting to each of the UEs 410 on a plurality of carriers (block 420). At each of the UEs 410, the transmission is received over the plurality of carriers (block 422) and then each of the UEs 410 makes measurements of channel condition for each carrier (block 424). Rather than computing a CQI value for each carrier, the UEs 410 can compute a single representative CQI value (block 505). For example, the representative CQI value may indicate a minimum CQI value seen in any of the carriers in the plurality of carriers or the representative CQI value may indicate an average or maximum CQI value seen in any of the carriers. Alternatively, the representative CQI value may be a weighted average of the CQI values for each of the carriers.

According to a preferred embodiment of the present invention, the representative CQI value represents the channel condition of all carriers in the plurality of carriers. If the BS 405 transmitted the transmission to the UE 410 on all of the carriers of the multi-carrier communications system, then the representative CQI value computed by the UE 410 provides a representation of all of the carriers in the multi-carrier communications system. If the BS 405 used a subset of available carriers to transmit the transmission to the UE 410, then the representative CQI value computed by the UE 410 provides a representation of the subset of available carriers used to transmit the transmission only. Note that in measuring the channel condition and computing the representative CQI value, the UE 410 may use the same techniques as discussed previously.

After computing the representative CQI value, the UE 410 can then quantize and label the computed CQI for each carrier and then encode the CQI for transmission (block 507). Note that the UE 410 may use the same techniques and algorithms for quantization and labeling as discussed previously. However, rather than performing the quantization and labeling for each CQI of each carrier, the UE 410 performs the quantization and labeling only for the representative CQI value. The encoding of the quantized and labeled representative CQI value can involve the application of an error detecting and correcting code to help protect the representative CQI value from damage during transmission. Finally, the encoded, quantized and labeled representative CQI value can be fedback to the BS 405 via a feedback control channel (block 509).

Back at the BS 405, the BS 405 after having received the representative CQI value from each of the UEs 410 can decode the CQI values (block 511). Since each UE 410 computed a single representative CQI value, then the BS 405 will receive a number of representative CQI values that is equal to the number of UEs 410 in the multi-carrier communications system. The BS 405 can then make use of the representative CQI values from the various UEs 410 to schedule transmissions to the UEs 410 (block 434). For example, the BS 405 may elect to place more transmissions on a set of carriers that has a high representative CQI value and fewer transmissions on a set of carriers that has a low representative CQI value. In addition to scheduling transmissions to the UEs 410, the BS 405 can make MCS determinations (block 436) for each set of the carriers, using the representative CQI values. For example, in a set of carriers with a low representative CQI value, the BS 405 may elect to use a modulation-coding scheme that will provide high degree of tolerance to errors at the expense of data throughput to help ensure that transmissions will be successfully received. While in a set of carriers with a high representative CQI value, the BS 405 may elect to use a modulation-coding scheme that will minimize overhead to maximize data throughput. After the BS 405 has performed scheduling (block 434) and MCS determinations (block 436), the BS 405 can commence transmissions to the UEs (block 420).

The computation and feedback of a representative CQI value for each UE 410 can be well suited for situations when a transmission to a UE can be multiplexed across multiple carriers. In such a situation, an average (or minimum or maximum) channel quality indicator is more relevant in the scheduling process. Additionally, the use of a representative CQI value can reduce CQI feedback requirements. This can be beneficial even if the transmission to a UE 410 makes use of only a single carrier, since reducing network traffic on the feedback channels can improve overall network performance.

Alternatives to the sequences of events displayed in FIGS. 4 and 5 may be possible. A first alternative can be that the feedback of the CQI values can be performed in a serial fashion. For example, rather than having the UEs 410 provide the CQI value for each carrier to the BS 405 all within a single report period, the UEs 410 can report a CQI value for a first carrier within a first report period and then in a second report period, report a CQI for a second carrier, and so on. This can proceed in a round robin or pseudo-random manner. An advantage is to obtain benefits of frequency diversity, especially for low Doppler operating environments. Another alternative can be that rather reporting a CQI value that corresponds to a data rate that can be support on a carrier, the CQI could represent a difference between a data rate that can be supported on a carrier at a previous report period and a current data rate that can be supported on the carrier. This can further be simplified by having the UEs 410 report only a change for a carrier with the largest difference.

Yet another alternative could be to have the BS 405 notify the UEs 410 that the CQI reporting method should be changed based upon whether transmissions are to occur over a single carrier or multiplexed over a plurality of carriers. A further alternative may be that the CQI information could be transmitted on a single carrier of the multi-carrier communications system, especially if the single carrier is maintained for compatibility reasons, such as a carrier in 3xEV-DV used to provide compatibility with 1xEV-DV. Yet another alternative can be that the CQI values can be distributed on multiple carriers, with the CQI value being transmitted on a particular carrier corresponding to a data rate supportable on the carrier.

With reference now to FIG. 6, there is shown a diagram illustrating a portion of a BS 600 of a multi-carrier communications system, wherein the BS 600 makes use of channel quality indicators to schedule and determine modulation-coding schemes for transmissions from the BS 600, according to a preferred embodiment of the present invention. The diagram of the BS 600 includes a portion that is responsible for taking a data stream and performing all necessary operations needed to transmit the data to its intended receiver(s). A packet formatter/scheduler 605 may be responsible for operations such as taking data from a data stream input and formatting it into proper transmission packets and then scheduling the transmission of the packets on the carriers of choice. Since the BS 600 may transmit to multiple UEs, the packet formatter/scheduler 605 may need to be capable of partitioning data based upon the different UEs as well as maintaining a transmission schedule for the different UEs. In addition to packet formatting and transmission scheduling, the packet formatter/scheduler 605 may also perform carrier(s) selection. For example, it may be specified that a packet be transmitted using two carriers. The packet formatter/scheduler 605 may then select the two carriers based on the carriers' CQI, for instance.

After packet formatting and scheduling, a modulator 610 can be used to apply the proper modulation needed to enable the transmission of the formatted packet using the selected carriers. Since it may be possible that the multiple carriers in a multi-carrier communications system to use different modulation techniques, the modulator 610 may need to be capable of applying the different modulation techniques to the formatted packets as needed. After modulation, a digital-to-analog converter (DAC) 615 can be used to convert the modulated signal into its analog representation and a mixer 620 can be used to bring the analog signal to proper frequencies for transmission purposes. A filter 625 can make sure that the analog signal fits within the frequency characteristic requirements of the carriers being used. Finally, the analog signal is provided to an antenna 630, which broadcasts the signal over-the-air.

A processor 635, such as a processing element, a general purpose processing unit, a custom designed processor, and so forth, can be used to control the operation of the BS 600 by executing control applications, special functions, and so on. If the packet formatter/scheduler 605 and the modulator 610 are designed to high-level functions, then when the BS 600 receives CQI values from the UEs, the processor 635 can provide the CQI values to the packet formatter/scheduler 605 and the modulator 610 so that the proper scheduling and selection carriers and modulation-coding schemes can be performed based on the CQI values. In such a situation, the processor 635 may not need to perform significant processing on the CQI values. However, if the packet formatter/scheduler 605 and the modulator 610 are designed to have minimal functionality, then the processor 635 may need to perform significant processing. For example, the processor 635 may need to maintain the CQI values for the various UEs, provide the CQI values for a UE whose transmissions are currently being formatted, scheduled, and modulated by the packet formatter/scheduler 605 and modulator 610 to the packet formatter/scheduler 605 and modulator 610, initiate new transmissions to update CQI values, and so on.

In addition to the two CQI scenarios discussed above (one CQI representing a plurality of carriers per user and one CQI per carrier per user), a wide range of other possibilities exist. An alternative to the two CQI scenarios is to have plurality of CQIs with each CQI representing more than one carrier, but not all carriers of a single user. For example, in a situation where there are four carriers, there can be two CQIs, a first CQI representing two carriers and a second CQI representing two carriers. The first CQI can represent carriers one and two and the second CQI can represent carriers three and four. Alternatively, a first CQI can represent carriers exceeding a threshold and a second CQI can represent carriers below the threshold. In another alternative for a four carrier case, three CQIs can be used, a first CQI representing carrier one, a second CQI representing carrier two, and a third CQI representing carriers three and four. In general, a CQI can represent a wide number of carriers, ranging from one carrier per CQI per user to multiple carriers per CQI per user. As long as both a source of the CQI information and a receiver of the CQI information know how the CQI was computed, the CQI can convey useful information regarding channel quality.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for providing channel quality indicators to a transmitter of a multi-carrier communications system, the method comprising:
receiving a transmission from the transmitter, wherein the transmission occurs over a plurality of carriers;
measuring a channel condition for each carrier in the plurality of carriers;
computing a channel quality indicator based upon the measured channel condition; and
providing the channel quality indicator to the transmitter.

2. The method of claim 1, wherein the channel quality indicator corresponds to a data rate that can be supported by a carrier.

3. The method of claim 1, wherein the measured channel condition comprises one or more of the following: a signal-to-noise ratio (SNR), a signal-to-interference plus noise ratio (SINR), or a signal-to-noise plus distortion ratio (SNDR).

4. The method of claim 1, wherein the transmission is a data transmission, a control transmission, a specially encoded transmission, or a pilot channel transmission.

5. The method of claim 1 further comprising after the computing, quantizing and labeling the channel quality indicator.

6. The method of claim 5 further comprising after the quantizing and labeling, encoding the channel quality indicator with an error correcting code.

7. The method of claim 1, wherein the providing comprises transmitting the channel quality indicator on a feedback control channel.

8. The method of claim 1, wherein the channel quality indicator comprises a plurality of channel quality indicators, with one channel quality indicator per carrier in the plurality of carriers.

9. The method of claim 8, wherein one channel quality indicator out of the plurality of channel quality indicators is provided to the transmitter per report period.

10. The method of claim 1, wherein the channel quality indicator is a representative channel quality indicator, wherein the channel quality indicator represents a minimum, an average, or a maximum channel quality indicator selected from a plurality of channel quality indicators.

11. The method of claim 10, wherein the channel quality indicator is a representative channel quality indicator, and wherein the channel quality indicator is representative of a subset of carriers in the plurality of carriers.

12. The method of claim 11, wherein there are a plurality of channel quality indicators, each channel quality indicator representative of a subset of carriers in the plurality of carriers, and wherein the plurality of channel quality indicators provides channel quality information for every carrier in the plurality of carriers.

13. The method of claim 12, wherein each channel quality indicator in the plurality of channel quality indicators is assigned a subset of carriers.

14. The method of claim 12, wherein each channel quality indicator in the plurality of channel quality indicators is assigned a subset of carriers based upon a measure of carrier quality.

15. The method of claim 1, wherein the channel quality indicator provided to the transmitter is a difference between a current channel quality indicator and a previous channel quality indicator.

16. The method of claim 1, wherein there are a plurality of electronic devices, and wherein each electronic device performs the receiving, measuring, computing, and providing.

17. The method of claim 16, wherein each electronic device provides the channel quality indicator on a single feedback control channel.

18. The method of claim 16, wherein a single electronic device provides the channel quality indicator during a single transmit time interval.

19. A method for generating channel quality indicators in a multi-carrier communications system, the method comprising:
transmitting a message to each electronic device in the multi-carrier communications system, wherein a transmission to an electronic device occurs over every carrier assigned to the electronic device; and
receiving a channel quality indicator from each electronic device.

20. The method of claim 19, wherein the message comprises a data message, a control message, a specially encoded message, or a pilot channel message.

21. The method of claim 19, wherein a single message is sent to each electronic device.

22. The method of claim 19, wherein a different message is sent to different electronic devices.

23. The method of claim 19 further comprising after the receiving, verifying that the channel quality indicator from each electronic device is error free.

24. The method of claim 19, wherein the channel quality indicators are received on a feedback control channel.

25. The method of claim 24, wherein each electronic device transmits its channel quality indicators in a separate transmit time interval.
